(19) United States
(12) Patent Application Publication
(10) Pub. No.: US 2013/0033429 A1
(43) Pub. Date: Feb. 7, 2013

(54) METHOD OF NOTETAKING WITH SOURCE DOCUMENT REFERENCING

(71) Applicant: Kia Silverbrook, Balmain (AU)

(72) Inventor: Kia Silverbrook, Balmain (AU)

(73) Assignee: Silverbrook Research Pty Ltd.

(21) Appl. No.: 13/197,736

(22) Filed: Aug. 3, 2011

(51) Int. Cl. G06F 3/033; G06F 3/01; G06F 3/041

(52) U.S. Cl. 345/166; 345/173; 345/156; 345/179

(57) ABSTRACT

A method of notetaking includes the steps of: displaying a source document on a display device; writing notes on a substrate relating to the displayed source document to create handwritten notes; generating digital ink representing the handwritten notes; and indexing the digital ink with an identifier for the displayed source document so that the displayed source document is retrievable when accessing the notes. The displayed source document has no association with the substrate prior to writing the notes.

### FIELD OF INVENTION

The present invention relates generally to handwritten notetaking and, more particularly, to a method and system for improving the utility of handwritten notes by augmentation with other media.

### CROSS REFERENCES

Various methods, systems and apparatus relating to the present invention are disclosed in the following US patents/patent applications filed by the applicant or assignee of the present invention:

| | | | |
|---|---|---|---|
| 6,982,798 | 7,148,345 | 7,406,445 | 6,832,717 |
| 6,870,966 | 7,580,765 | 7,263,270 | 6,681,045 |
| 2005/0024510 | 2006/0028459 | 2007/0040817 | 12/477,863 |
| 6,808,330 | 2008/0193007 | 2008/0193044 | 12/178,619 |
| 12/694,264 | 12/694,269 | 12/694,271 | 12/694,274 |
| 2007/0130117 | 2008/0097823 | 2008/0192234 | 2008/0273010 |
| 2008/0191024 | 12/506,215 | | |

The disclosures of these applications and patents are incorporated herein by reference.

### BACKGROUND OF THE INVENTION

There has been a significant shift towards a paperless world in recent years. Sales of traditional printed books are diminishing with an increasing use of e-books viewable via dedicated e-book viewer devices (e.g. Amazon Kindle™), tablet computers (e.g. Apple iPad®) and the like.

Nevertheless, paper remains a ubiquitous medium for most people. Paper has the advantages of being readily portable, readable in sunlight, permanent and tangible in the physical world. In view of the unique advantages of paper, there have been significant efforts by the present Applicant and others to employ paper as an interface to the digital world, rather than merely as a medium for physically capturing and displaying handwritten or printed information. In this way, the value of paper is increased, and the bridge between the paper world and the digital world means that they become complementary rather than competing media.

The present Applicant's Netpage system (see, for example, U.S. Pat. No. 6,870,966) employs an optically imaging sensing device to read a position-coding pattern printed on a page (“Netpage”). A computer system identifies an action associated with a unique page identity and coordinate location which are decoded from the read position-coding pattern. Superimposition of visible page content with the position-coding pattern means that, from a user's perspective, the paper appears as traditional paper with a link to the digital world via the Netpage pen. In one form, Netpages may be used for notetaking whereby a user inputs handwritten information onto the page and the handwritten notes are captured via the Netpage pen as digital ink, which is stored in a computer system for subsequent retrieval (see U.S. Pat. No. 6,681,045, the contents of which are incorporated herein by reference).

Notetaking is a particularly useful paper-based activity for students, journalists etc. Although digital media are being increasingly used by students, notetaking remains a cornerstone of the studying process, whether it be in the classroom, the lecture theatre, the library or at home.

Hitherto, the present Applicant has described a Netpage sensing device with an integrated microphone for capturing audio at the same time as a page-based interaction with a printed Netpage (see, for example, U.S. Pat. No. 7,580,765, the contents of which are incorporated herein by reference). In this way, a Netpage interaction with a particular page/coordinate location may be augmented with audio captured via the microphone. The captured audio may be retrieved for playback via a subsequent interaction with the same page/coordinate location. The Applicant has described as similar system for playback of video (see U.S. Pat. No. 7,263,270).

A Livescribe™ Smartpen is a commercially-available device aimed primarily at students for simultaneously capturing audio whilst notetaking. The Livescribe™ Smartpen seeks to augment notetaking with audio so that retrieved handwritten notes have an associated audio file, which is also retrievable when the notes are accessed.

It would be desirable to improve the notetaking experience for students and other notetakers. It would be particularly desirable for notetakers to access conveniently a primary source of their notes, even in scenarios where the primary source is not the spoken word of a lecturer, teacher, interviewee etc. It would further be desirable for notetakers to access the primary source of their notes without requiring a pen which does the job of capturing source media as well as capturing handwritten notes as digital ink. The integration of additional media capture devices (e.g. a microphone) into an optically imaging pen inevitably impacts on the overall cost and form factor of the pen.

### SUMMARY OF INVENTION

In a first aspect, there is provided a method of notetaking comprising the steps of:

displaying a source document on a first display device;

writing notes on a printed substrate relating to the displayed source document using an optically imaging pen to create handwritten notes, the printed substrate comprising a position-coding pattern identifying a substrate identity and a plurality of coordinate locations on the substrate;

imaging the position-coding pattern whilst writing the notes and generating digital ink, the digital ink identifying the substrate identity and a sequence of coordinate locations representing the handwritten notes; and

indexing the digital ink with at least one identifier for the displayed source document, such that the displayed source document is retrievable when accessing the notes, wherein the displayed source document has no association with the printed substrate prior to writing the notes.

The method according to the present invention advantageously enables users to conveniently access source documents, from which notes are taken, when those notes are subsequently accessed. In this way, the intrinsic utility of the notes is increased by virtue of their association with original source material.

Optionally, the method further comprises the steps of:
subsequently interacting with handwritten notes on the printed substrate using the optically imaging pen; and
retrieving and displaying the source document on a second display device, the source document being a same source document displayed on the first display device at the time of writing the notes.

Optionally, the first and second display devices are the same display device, such as a tablet computer.

Optionally, the method further comprises the steps of:
subsequently displaying the handwritten notes on a third display device, the displayed handwritten notes being based on the digital ink; and
identifying or displaying at least part of the source document together with the displayed handwritten notes, the source document being a same source document displayed on the first display device at the time of writing the notes.

Optionally, the first and third display devices are the same display device, such as a tablet computer.

Optionally, the source document comprises multiple pages and the digital ink is indexed with a plurality of identifiers for a plurality of individual pages of the source document.

Optionally, the digital ink comprises first and second digital ink strokes, and wherein a first digital ink stroke is indexed with a first displayed source document and a second digital ink stroke is indexed with a second displayed source document. For example, the first and second displayed source documents may be different pages (e.g. consecutive pages) of an e-book.

Optionally, the source document is a multimedia document comprising one or more of: text, graphics, audio and video content.

Optionally, the source document is an e-book, a pdf document, a slideshow presentation, a spreadsheet or an internet webpage.

Optionally, the identifier is an electronic bookmark identifying one chapter or one page of the e-book.

Optionally, the first display device is a tablet computer, an e-book viewer, a laptop computer, a mobile phone or a personal digital assistant.

Optionally, a context of the first display device at the time of displaying the source document is indexed with the digital ink.

Optionally, the context is selected from at least one of: an application open on the first display device, a webpage open on the first display device, a video playing on the first display device, an audio file playing on the first display device, a geographic location and a time zone.

Optionally, the method further comprises the steps of:
the pen sending the digital ink to the first display device in real-time; and
the first display device indexing the received digital ink with the identifier for the displayed source document.

Optionally, the method further comprises the steps of:
the first display device sending the identifier of the displayed source document to the pen; and
the pen tagging the digital ink with the identifier.

Optionally, the method further comprises the steps of:
the first display device logging source documents displayed on the device;
timestamping each change of the displayed source document; and
timestamping the digital ink,
   wherein the first display device and the pen have synchronized clocks for timestamping.

Optionally, the method further comprises the steps of:
sending the timestamped digital ink to the first display device;
the first display device comparing received timestamped digital ink with timestamped changes of the displayed source document; and
indexing the timestamped digital ink with one or more identifiers for the displayed source documents on the basis of the comparison.

Optionally, a remote computer system receives the digital ink and monitors a display output of the first display device.

Optionally, a user identifies the displayed source document using the pen and the digital ink comprises a tag indicating the displayed source document.

In a second aspect, there is provided a system for notetaking comprising:
a first display device for displaying a source document to a user;
a printed substrate for receiving handwritten notes relating to the displayed source document, the printed substrate comprising a position-coding pattern identifying a substrate identity and a plurality of coordinate locations on the substrate;
an optically imaging pen having a writing nib, the pen being configured for imaging the position-coding pattern whilst writing the notes and generating digital ink, the digital ink identifying the substrate identity and a sequence of coordinate locations representing the handwritten notes; and
a computer system configured for indexing the digital ink with at least one identifier for the displayed source document, such that the displayed source document is retrievable when accessing the notes.

Optionally, the first display device contains the computer system. For example the first display device may be a tablet computer configured for storage of digital ink.

Optionally, the computer system is a personal computer or a server, which is different than the first display device.

In a third aspect, there is provided a method of notetaking comprising the steps of:
displaying a source document on a first display device;
writing notes on a substrate relating to the displayed source document to create handwritten notes;
generating digital ink representing the handwritten notes; and
indexing the digital ink with at least one identifier for the displayed source document, such that the displayed source document is retrievable when accessing the notes, wherein the displayed source document has no association with the substrate prior to writing the notes.

Optionally, the substrate is a touchscreen and the notes are written using a stylus, and wherein a processor communicating with the touchscreen generates the digital ink. The substrate may be the touchscreen of a tablet computer or mobile phone.

Optionally, the substrate is a digitizing tablet and the notes are written using a stylus, and wherein the digitizing tablet generates the digital ink. The notes may be written directly on a screen of the digitizing tablet or written on a sheet of paper overlying the screen.

Optionally, the substrate is a passive substrate, such as paper which is not overlain on an electronic digitizing device.

Optionally, the notes are written with a pen comprising a wave signal emitter, and wherein the digital ink is generated by a processor in communication with a wave signal detector configured for detecting the wave signals emitted by the pen.

Optionally, the pen comprises an ultrasonic emitter for emitting an ultrasonic wave signal and the digital ink is generated by a device comprising one or more microphones for receiving the ultrasonic wave signal and a processor for converting the received ultrasonic wave signal into digital ink.

Optionally, the notes are written with a pen comprising a motion sensor, and wherein the pen generates the digital ink using movement data determined by the motion sensor.

Optionally, the pen comprises at least one of: an accelerometer, a gyroscope, an optical mouse, and an optical image sensor.

Optionally, the substrate is printed with a position-coding pattern encoding a plurality of coordinate locations, and the pen comprises an optical image sensor for imaging the position-coding pattern and generating the digital ink using the imaged position-coding pattern.

Optionally, the position-coding pattern identifies a substrate identity and the digital ink generated by the pen identifies the substrate identity.

Optionally, the method comprises the steps of:
sending the digital ink to the first display device in real-time; and
the first display device indexing the received digital ink with the identifier for the displayed source document.

Optionally, the method comprises the steps of:
generating the digital ink in the first display device in real-time; and
the first display device indexing the received digital ink with the identifier for the displayed source document.

In a fourth aspect, there is provided a system for notetaking comprising:
a display device for displaying a source document;
a substrate for receiving handwritten input;
a pen or stylus for writing notes on the substrate to create handwritten notes, the notes relating to the displayed source document;
means for generating digital ink representing the handwritten notes; and
a computer system for indexing the digital ink with at least one identifier for the displayed source document, such that the displayed source document is retrievable when accessing the notes,
   wherein the displayed source document has no association with the substrate prior to writing the notes.

The substrate may be a passive substrate, such as paper, or an active substrate, such as a digitizing tablet or tablet computer.

The means for generating digital may be a processor contained in the pen or stylus, the substrate on which notes are written or a remote computer system.

### BRIEF DESCRIPTION OF DRAWINGS

Preferred and other embodiments of the invention will now be described, by way of non-limiting example only, with reference to the accompanying drawings, in which:

FIG. 1 is a sample page of a printed notepad for notetaking;

FIG. 2 shows a Netpage pen sending digital ink to a tablet computer in real-time;

FIG. 3 is a perspective view of a Netpage pen;

FIG. 4 is a longitudinal section of the Netpage pen shown in FIG. 3;

FIG. 5A shows transmission of a page identifier to the Netpage pen;

FIG. 5B shows the Netpage pen connected to a laptop computer via a wired connection;

FIG. 6A shows a Netpage pen and tablet computer having synchronized internal clocks;

FIG. 6B shows the Netpage pen connected to the tablet computer via a wired connection;

FIG. 7 shows a local network having a local server communicating with a Netpage pen and a tablet computer.

### DETAILED DESCRIPTION OF THE INVENTION

### 1 Netpage System Overview

### 1.1 Netpage System Architecture

By way of background, the Netpage system employs a printed page having graphic content superimposed with a Netpage coding pattern. The Netpage coding pattern typically takes the form of a coordinate grid comprised of an array of millimetre-scale tags. Each tag encodes the two-dimensional coordinates of its location as well as a unique identity for the page. When a tag is optically imaged by a Netpage reader (e.g. pen), the pen is able to identify the page identity as well as its own position relative to the page. When the user of the pen moves the pen relative to the coordinate grid, the pen generates a stream of positions. This stream is referred to as digital ink. A digital ink stream also records when the pen makes contact with a surface and when it loses contact with a surface, and each pair of these so-called pen down and pen up events delineates a stroke drawn by the user using the pen.

In some embodiments, active buttons and hyperlinks on each page can be clicked with the sensing device to request information from the network or to signal preferences to a network server. In other embodiments, text written by hand on a page is automatically recognized and converted to computer text in the netpage system, allowing forms to be filled in. In other embodiments, signatures recorded on a netpage are automatically verified, allowing e-commerce transactions to be securely authorized. In other embodiments, text on a netpage may be clicked or gestured to initiate a search based on keywords indicated by the user.

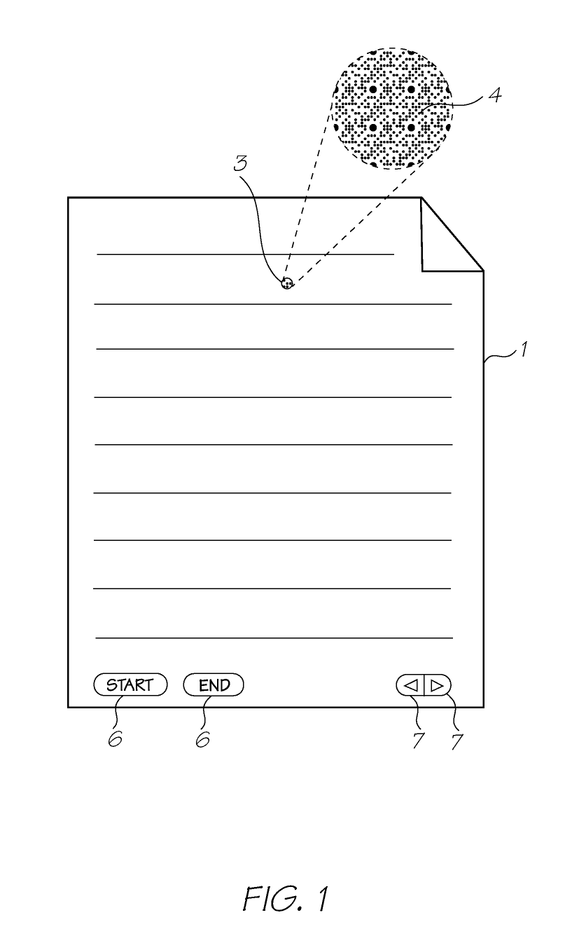

As illustrated in FIG. 1, a printed netpage 1 may be in the form of notepaper on which a user enters handwritten information. The notepaper can be filled in by the user both physically, on the printed page, and “electronically” via the digital ink generated by the pen. The netpage 1 consists of a graphic impression 2, printed using visible ink, and a surface coding pattern 3 superimposed with the graphic impression. The coding pattern 3 is typically printed with an infrared ink and the superimposed graphic impression 2 is printed with colored ink(s) having a complementary infrared window, allowing infrared imaging of the coding pattern 3. The coding pattern 3 is comprised of a plurality of contiguous tags 4 tiled across the surface of the page. Examples of some different tag structures and encoding schemes are described in, for example, US 2008/0193007; US 2008/0193044; US 2009/0078779; US 2010/0084477; US 2010/0084479; U.S. Ser. No. 12/694,264; U.S. Ser. No. 12/694,269; U.S. Ser. No. 12/694,271; and U.S. Ser. No. 12/694,274, the contents of each of which are incorporated herein by reference.

A corresponding page description is stored digitally and indexed with the page identity encoded in the coding pattern 3. The page description describes the individual elements of the netpage 1 and accepts digital ink generated by the pen. The page description may be stored in a computer system in communication with the netpage pen. Alternatively, or additionally, the netpage pen may have an onboard computer system which stores the page description and any digital ink associated with the page description.

The page description has an input description describing the type and spatial extent (zone) of interactive elements on the netpage 1 enabling the netpage system to correctly interpret input via the netpage. For example, the “START” and “END” buttons 6 have a zone in the page description which correspond to the spatial extent of the corresponding printed buttons. The majority of the notepaper shown in FIG. 1 is comprised of a lined notepad region which accepts handwritten input. Digital ink generated by the pen in this region is stored by the corresponding page description as handwritten strokes and/or, according to a user preference, as computer text using Intelligent Character Recognition.

The netpages 1 may be printed digitally and on-demand by a suitably configured printer, such as the netpage printer described in U.S. Pat. No. 6,982,798. Alternatively, the netpages may be printed by traditional analog printing presses, using such techniques as offset lithography, flexography, screen printing, relief printing and rotogravure, as well as by digital printing presses, using techniques such as drop-on-demand inkjet, continuous inkjet, dye transfer, and laser printing.

Multiple netpages (for example, those printed by analog printing presses) can share the same page description. However, to allow input through otherwise identical pages to be distinguished, each netpage may be assigned a unique page identifier in the form of a page ID (or, more generally, an impression ID or region ID). The page ID has sufficient precision to distinguish between a very large number of netpages.

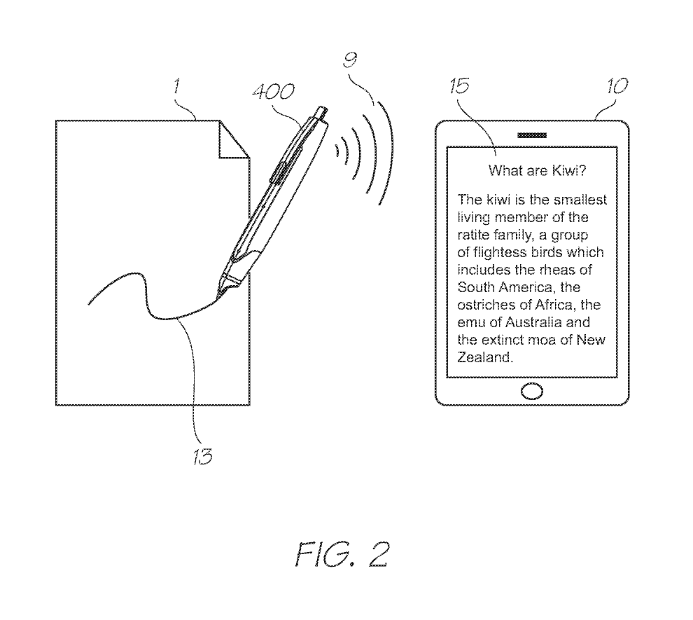

In the example shown in FIG. 2, the netpage pen 400 interacts with the printed netpage 1 by writing notes on the page and generating digital ink representing the handwritten notes. A tag is sensed by a 2D area image sensor in the netpage pen 400, and the digital ink corresponding to decoded tag data is transmitted via a short-range radio link 9 (e.g. Bluetooth®) to a computer system, in this instance a tablet computer 10. The digital ink is comprised of a set of timestamped strokes, and each stroke compriseing a set of timestamped pen positions. Pen strokes may comprise other data, such as pen orientation, nib force and/or pen ID.

The computer 10 retrieves the page description corresponding to the page identity of the netpage 1 and associates the received digital ink with this page description. Hence, the handwritten notes are digitally stored and associated with the page identity of the netpage for subsequent retrieval.

It is important that the netpage pen 400 recognizes the page ID and position on every interaction with the page, since the interaction is stateless. Tags are error-correctably encoded to make them partially tolerant to surface damage.

The system may operate locally with local communication between the pen 400 and the computer system 10. Alternatively, or additionally, the computer system 10 may act as a relay device for relaying digital ink to a remote netpage server, which stores page descriptions and associated digital for retrieval via a netpage network.

The computer system 10 can be configured to support any number of netpage pens 400, and a netpage pen can work with any number of computers. In a preferred implementation, each netpage pen 400 has a unique identifier, which allows each user to maintain a distinct profile with respect to the netpage system.

As used herein, the term “pen” refers to any handheld pen-shaped implement with which a user can make writing motions on a substrate. A pen may have a marking nib or a non-marking nib. Typically, a pen having a non-marking nib is referred to as a stylus in the art, although the terms “pen” and “stylus” are essentially interchangeable.

### 1.2 Netpage Tags

Each tag 4, contained in the position-coding pattern 3, identifies an absolute location of that tag within a region of a substrate.

Each interaction with a netpage should also provide region identity together with the tag location. In a preferred embodiment, the region to which a tag refers coincides with an entire page, and the region ID is therefore synonymous with the page ID of the page on which the tag appears. In other embodiments, the region to which a tag refers can be an arbitrary subregion of a page or other surface. For example, it can coincide with the zone of an interactive element, in which case the region ID can directly identify the interactive element.

As described in some of the Applicant's previous applications (e.g. U.S. Pat. No. 6,832,717 incorporated herein by reference), the region identity may be encoded discretely in each tag 4. As described other of the Applicant's applications (e.g. U.S. application Ser. Nos. 12/025,746 & 12/025,765 filed on Feb. 5, 2008 and incorporated herein by reference), the region identity may be encoded by a plurality of contiguous tags in such a way that every interaction with the substrate still identifies the region identity, even if a whole tag is not in the field of view of the sensing device.

Each tag 4 should preferably identify an orientation of the tag relative to the substrate on which the tag is printed. Strictly speaking, each tag 4 identifies an orientation of tag data relative to a grid containing the tag data. However, since the grid is typically oriented in alignment with the substrate, then orientation data read from a tag enables the rotation (yaw) of the netpage pen 400 relative to the grid, and thereby the substrate, to be determined

A tag 4 may also encode one or more flags which relate to the region as a whole or to an individual tag. One or more flag bits may, for example, signal the netpage pen 400 to provide feedback indicative of a function associated with the immediate area of the tag, without the reader having to refer to a corresponding page description. A netpage reader may, for example, illuminate an “active area” LED when positioned in the zone of a button or hyperlink.

A tag 4 may also encode a digital signature or a fragment thereof. Tags encoding digital signatures (or a part thereof) are useful in applications where it is required to verify a product's authenticity. Such applications are described in, for example, US Publication No. 2007/0108285, the contents of which is herein incorporated by reference. The digital signature may be encoded in such a way that it can be retrieved from every interaction with the substrate. Alternatively, the digital signature may be encoded in such a way that it can be assembled from a random or partial scan of the substrate.

It will, of course, be appreciated that other types of information (e.g. tag size etc) may also be encoded into each tag or a plurality of tags.

For a full description of various types of netpage tags 4, reference is made to some of the Applicant's previous patents and patent applications, such as U.S. Pat. No. 6,789,731; U.S. Pat. No. 7,431,219; U.S. Pat. No. 7,604,182; US 2009/0078778; and US 2010/0084477, the contents of which are herein incorporated by reference.

### 1.3 Netpage Pen

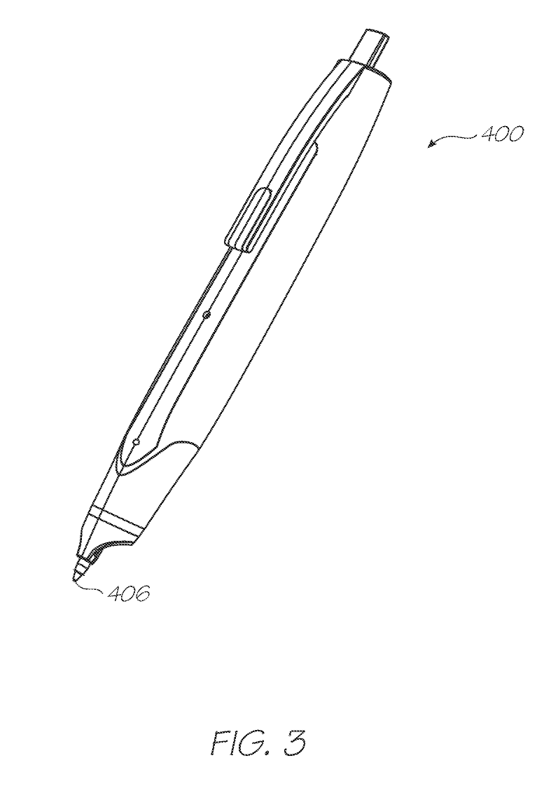

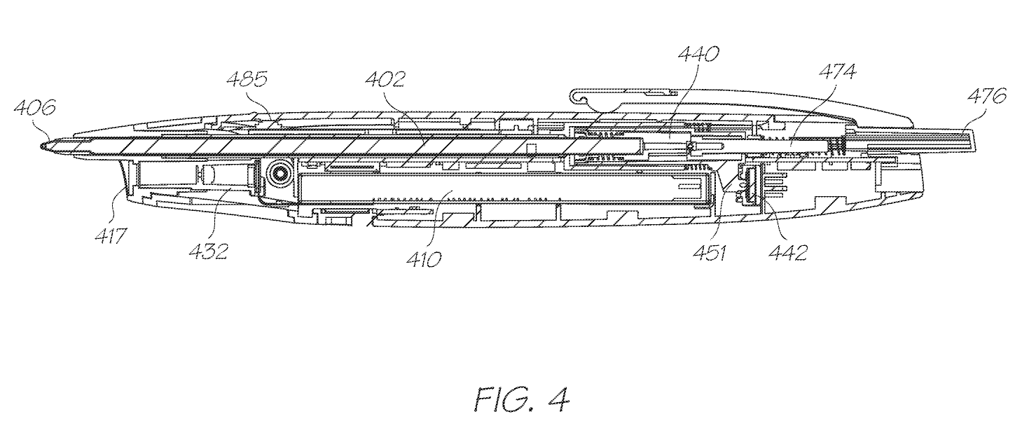

Referring to FIGS. 3 and 4, the Netpage pen 400 is a motion-sensing writing instrument which works in conjunction with a tagged Netpage surface (see Section 1.2). The Netpage pen 400 typically includes a conventional ballpoint pen cartridge 402 having a nib 406 for marking the surface, an image sensor 432 and processor for capturing the absolute path of the pen on the surface and identifying the surface, a force sensor 442 for simultaneously measuring the force exerted on the nib 406, an optional Gesture button 485 for indicating that a Gesture is being captured, and a real-time clock for simultaneously measuring the passage of time.

During normal operation, the Netpage pen 400 regularly samples the encoding of a surface as it is traversed by the pen's nib 406. The sampled surface encoding is decoded by the Netpage pen to yield surface information comprising the identity of the surface, the absolute position of the nib of the Netpage pen on the surface, and the pose of the Netpage pen relative to the surface. The Netpage pen also incorporates a force sensor 442 that produces a signal representative of the force exerted by the nib on the surface. The force sensor senses nib forces via a pin 451, which is coupled to the pen cartridge when the cartridge is extended as shown in FIG. 4.

Each stroke is delimited by a pen down and a pen up event, as detected by the force sensor. Digital ink is produced by the Netpage pen as the timestamped combination of the surface information signal and optionally, the force signal and the Gesture button input. The digital ink thus generated represents a user's interaction with a surface—this interaction may then be used to perform corresponding interactions with applications that have pre-defined associations with portions of specific surfaces. (In general, any data resulting from an interaction with a Netpage surface coding may be referred to as “interaction data”).

Digital ink is usually transmitted to a computer system for interpretation, but until this is possible it may be stored within the Netpage pen's internal non-volatile memory. Once received by the computer system, the digital ink may be subsequently rendered in order to reproduce user markup of surfaces such as annotations or notes, or to perform handwriting recognition. A category of digital ink known as a Gesture also exists that represents a set of command interactions with a surface. (Although the computer system is typically remote from the pen 400 as described herein, it will be appreciated that the pen may have an onboard computer system for interpreting digital ink).

The pen 400 incorporates a Bluetooth radio transceiver for transmitting digital ink. When operating offline, the pen buffers captured digital ink in non-volatile memory. When operating online the pen transmits digital ink in real time as soon as all previously buffered digital ink has been transmitted.

The Netpage pen is powered by a rechargeable battery 410, which may be charged from a dedicated pen cradle or from a USB charger.

The Netpage pen's nib 406 may be user retractable, which serves the dual purpose of protecting surfaces and clothing from inadvertent marking when the nib is retracted, and signalling the Netpage pen to enter or leave a power-saving state when the nib is correspondingly retracted or extended. Referring to FIG. 4, the retraction mechanism 440 is actuated by a retraction button 476, which is coupled to the pen cartridge via a plunger 474.

Various embodiments of the Netpage pen 400 are described in greater detail in the Applicant's U.S. Pat. No. 6,870,966; U.S. Pat. No. 6,808,330; US Publication No. 2005/0024510; US Publication No. 2006/0028459; US Publication No. 2007/0040817; and U.S. application Ser. No. 12/477,863 filed on Jun. 3, 2009, the contents of each of which are herein incorporated by reference.

### 2 Document Referencing Via Notetaking

### 2.1 Background

Hitherto, the Applicant has described notetaking via printed netpages (U.S. Pat. No. 6,681,045). In its most basic form, notetaking simply associates digital ink with a corresponding page description for subsequent retrieval.

In many instances, notetaking is related to a source document, such as a textbook from which notes are taken. Increasingly, source documents are in electronic format and may be, for example, an e-book, a pdf or Word document, a spreadsheet, a slideshow presentation or an internet webpage. The present inventors have understood that the intrinsic value of a student's notes is increased if the source document, from which notes are derived, is quickly and conveniently available when the notes are subsequently accessed. Therefore, the present inventors have a devised a system which indexes handwritten notes with electronic source documents that are displayed on a display device when the user takes the notes. In this way, the source document is readily accessible when the handwritten notes are subsequently accessed.

As used herein, the term “source document” may refer to single-paged documents, a multi-paged document (e.g. book), an individual page of a multi-paged document or a set of pages (e.g. chapter) of a multi-paged document. The source document may be a conventional text and/or graphics format or the document may be a multimedia document, as known in the art.

In principle, a number of different methods may be employed for indexing the source document with digital ink, and the present invention is not intended to be limited to any particular method. Some of these methods are exemplified in Sections 2.2 to 2.6 below.

### 2.2 Indexing Page Identifiers Via Real-Time Digital Ink Transmission

Referring to FIG. 2, there is shown a netpage pen 400 making handwritten notes 13 on the coded notepaper 1. The handwritten notes 11 relate to the e-book page 15 displayed on the tablet computer 10, from which the user is making his/her notes. The pen 400 generates digital ink representing the handwritten notes 11 and sends this digital ink to the tablet computer 10 via a Bluetooth connection 9 in real-time as the digital is being generated. (Of course, wired connections between the pen 400 and the tablet computer 10 may be used instead of Bluetooth®, but these are necessarily less convenient for the user).

The tablet computer 10 receives the digital ink and indexes the digital ink with an identifier for the e-book page displayed on the tablet computer screen. The digital ink and indexed e-book page identifier are stored with a page description corresponding to the notepaper 1, identified using the page identity contained in the digital ink. Each stroke of digital ink received by the tablet computer 10 is indexed with an identifier of the page currently displayed on the device. When the user displays a new page of the e-book, the digital ink strokes received during display of that page are indexed with an identifier for the newly displayed page. Hence, all digital ink strokes received by the tablet computer 10 are indexed with a respective page identifier of the e-book.

A user may subsequently review the handwritten notes, but may not be able to recall the source document from which the notes are derived, particularly if several weeks, months or years have elapsed since the notes were created. The user may click on a point in the handwritten notes 13 using the netpage pen 400, which sends digital ink to the tablet computer identifying the page identity and coordinate location. The tablet computer 10 retrieves the corresponding page description and identifies the page of the e-book that was open at the time when the corresponding digital ink stroke was generated, using the identifier indexed with the digital ink stroke. The tablet computer 10 then opens the e-book at the identified page and displays the page to the user.

The user may click on a subsequent point in the handwritten notes 13 to display subsequent pages of the e-book displayed on the tablet computer 10. Alternatively, the user may use control buttons 7 on the notepaper 1 to skip between pages displayed on the tablet computer 10. The digital ink associated with clicking on the buttons 7 sends an instruction to the tablet computer 10 to skip to a preceding or subsequent page of the displayed e-book.

Alternatively, the user may choose to access his or her notes via the tablet computer 10 instead of the notepaper 1. In this case, the notes are displayed on the tablet computer 10 (using the stored digital ink) and a mouse-click or touch on the relevant part of the notes retrieves the corresponding page of the e-book, which can be displayed in a split screen format, displayed in a different window or simply identified via a pop-up link or similar. The tablet computer 10 may convert the handwritten notes into computer text using Intelligent Character Recognition techniques known in the art. The indexing with e-book page identifiers is preserved in the computer text (derived from the indexed digital ink) so that accessing the notes via the computer text representation provides the same information to the user as if he or she had accessed the original handwritten notes.

It will be appreciated that real-time streaming of digital ink strokes to the tablet computer 10 facilitates indexing of the digital ink with displayed e-book pages and obviates any requirement for temporal synchronization.

### 2.3 Indexing of Additional Context

Section 2.2 describes indexing of page identifiers with digital ink, such that each digital ink stroke has an associated page of an e-book, which was displayed on the tablet computer 10 at the time of generating that digital ink stroke. In one embodiment, the tablet computer 10 may be configured to capture at least part of an overall context of the tablet computer at the time each digital ink stroke was generated (or received). This context information may be used in addition to the displayed page identifier which is indexed with the digital ink strokes.

The overall context of the tablet computer 10 may include, for example, an open application, an open webpage, a recent browsing history, a video playing on the computer timestamped at the time the digital ink was generated (or received), an audio file playing on the computer timestamped at the time the digital ink was generated (or received), a geographic location, a time zone etc. The extent to which this additional context is retrieved when the stored digital ink is accessed may be determined by a user preference associated with a pen identity or the computer from which the digital ink is accessed.

### 2.4 Digital Ink Tagging in Pen

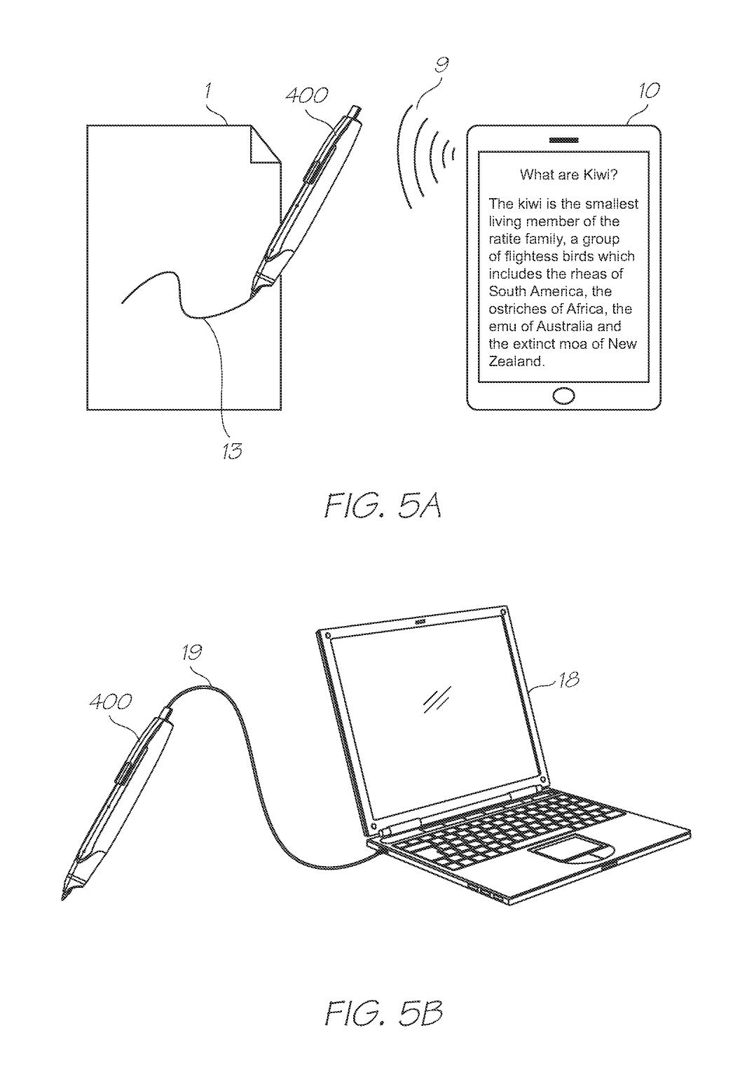

Referring to FIGS. 5A and 5B, there is shown an alternative scenario suitable for situations where the tablet computer 10 does not support digital ink interpretation. In this scenario, the tablet computer 10 (or other document viewer) sends data to the pen 400 during notetaking, as shown in FIG. 5A. The data comprises an identifier for the currently displayed page of the e-book from which the user is making notes. The pen 400 is then able to tag the digital ink with this identifier so that each digital ink stroke is indexed with the e-book page that was displayed at the time the stroke was generated. The indexed digital ink is stored in the pen's memory until such time that the pen is connected to a computer (or network) configured for receiving and interpreting the digital ink.

As shown in FIG. 5B, the netpage pen 400 is subsequently connected to a laptop computer 18 via a USB connection 19, although it will be appreciated that other types of connection (both wireless and wired) may be employed. The stored digital ink in the pen is received by the laptop computer 18 and archived with corresponding page descriptions.

Each stroke of the digital ink sent from the pen 400 in FIG. 5B is tagged with a corresponding identifier for an e-book page displayed at the time the digital ink stroke was generated. If the laptop computer 18 contains the e-book identified by the digital ink, then it will display the relevant page(s) when the digital ink is subsequently accessed. Of course, the digital ink may be accessed either via the printed notepaper 1 or via the laptop computer 18.

If the laptop computer 18 does not contain the e-book identified by the digital ink, then it may prompt the user to download or import a copy of the e-book to the computer for subsequent use. Equally, if digital ink stored on the tablet computer 10 is transferred to another computer, then the user may be prompted to import or download the relevant e-book(s) indexed with the digital ink.

Of course, digital ink tagging as described in this Section may occur simultaneously with digital ink transmission as described in Section 2.2 using two-way Bluetooth® communication. This enables notes, and more particularly indexed digital ink, to be conveniently transferred between several computers belonging to the same user via the pen 400.

Manual tagging of digital ink is also possible using e-book page identifiers written on the notepaper 1 (and recognized by Intelligent Character Recognition) or dedicated notebooks comprising buttons corresponding to particular pages or chapter of an e-book. However, such techniques for tagging digital ink are considered to less practical than other methods described herein.

### 2.5 Synchronized Clocks in Pen and Tablet Computer

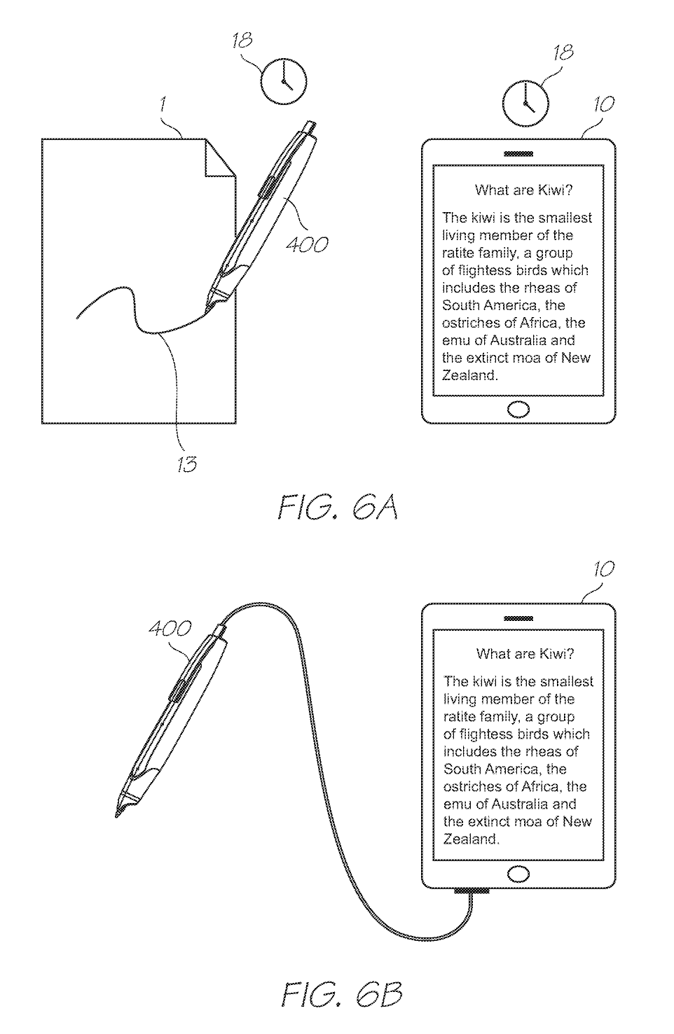

Referring to FIGS. 6A and 6B, there is shown an alternative scenario suitable for situations where the tablet computer 10 does not support real-time communication with the Netpage pen 400 via a Bluetooth® connection.

In FIG. 6A, both the pen 400 and the tablet computer 10 have clocks 18 that are synchronized with each other. Each digital ink stroke is timestamped with a date/time and, likewise, the tablet computer 10 maintains a persistent log of each displayed e-book page with a timestamp for each page turn. Other context information may be stored in this log as described in Section 2.3.

When the pen 400 is connected to the tablet computer 10 in FIG. 6B, the timestamped digital ink is compared with the log in the tablet computer to determine which page of the e-book was open at the time each digital ink stroke was generated. Accordingly, the tablet computer 10 indexes each digital ink stroke with an e-book page identifier corresponding to the page displayed at the time the digital ink stroke was generated. Thus, the relevant displayed e-book page(s) are retrievable whenever the notes are accessed.

### 2.6 Remote Monitoring of E-Book Viewer and Pen

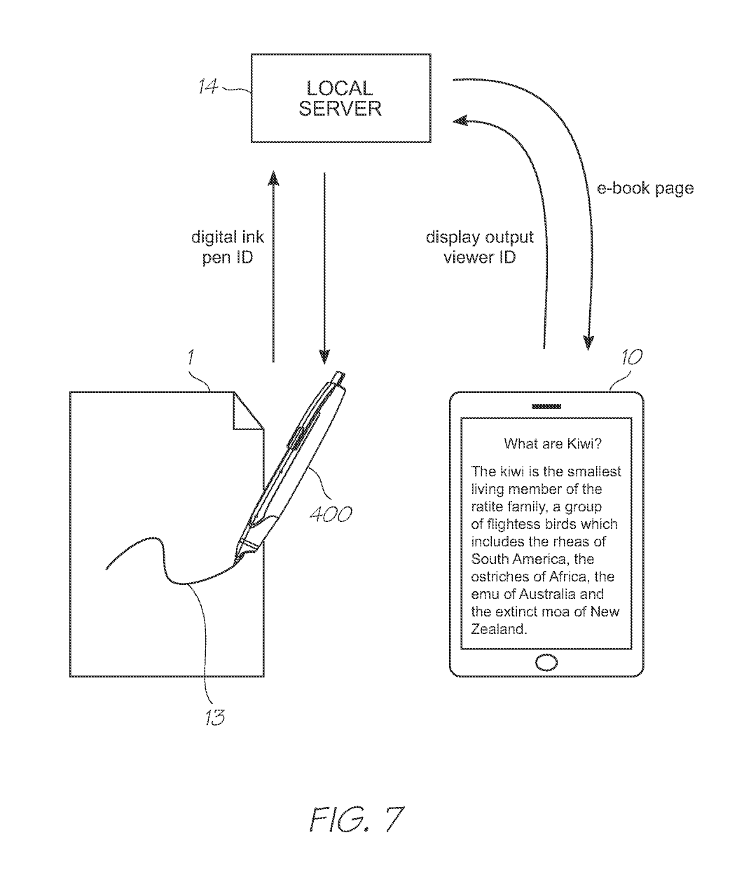

In, for example, a classroom situation, each student may have an e-book viewer (e.g. tablet computer 10) and a pen which are all linked via a local network. Referring to FIG. 7, a local server 14 may monitor the display output of the e-book viewer(s) 10 in the local network and simultaneously receive digital ink from pen(s) 400 in the network. Each pen 400 and e-book viewer 10 in the local network is identified via a respective pen ID and viewer ID, which are received by the local server 14.

For each student, the local server 14 marries the received digital ink from that student's pen 400 with the display output of that student's e-book viewer 10. Hence, the local server stores digital ink for each student's pen, which is indexed with the e-book pages from which that student was taking notes. The student may access these notes subsequently from the local server 14 by clicking on his or her handwritten notes 13, sending digital ink to the local server identifying a portion of these notes, and the local server sending the relevant e-book page to that student's display device. The local server 14 may store a library of e-books for access by each student.

Digital ink representing a student's handwritten notes may be downloaded to a student's home computer (e.g. via a secure internet connection) whilst retaining the indexing to the original source material.

An advantage of the arrangement shown in FIG. 7 is that it allows a teacher to monitor where each student has reached in a classroom notetaking exercise. A further advantage is that e-books can be stored centrally in an electronic library maintained by the local server 14, with access to each e-book controlled by the local server. For example, some students may not have access to certain e-books as determined by access rights associated with each student.

Of course, the scenario described above is not limited to classroom situations and may be suitable for any local network where notetaking is being performed.

### 3. Alternative Means For Generating Digital Ink

Although the present invention is conveniently employed in combination with the Applicant's Netpage system as described herein, it will be appreciated that it may be equally employed with alternative means for generating digital ink, provided that the digital ink faithfully represents notes which are handwritten on a substrate.

In the preferred embodiment of the Netpage system, digital ink is generated by a processor in the pen during interaction with a passive substrate (e.g. printed paper). The processor determines digital ink by decoding image data received from the image sensor—essentially the image sensor and processor are functioning as a highly accurate motion sensor. Alternatively, or additionally, the pen may comprise other types of motion sensors. As described in US Publication No. 2008/0192234, the contents of which are herein incorporated by reference, a relative motion sensor in the pen may sense motion independently of the image sensor so that absolute motion data generated by the processor may be supplemented with relative motion data. This arrangement can be used to save on processing power or improve the accuracy of motion sensing when image sampling rates are limited.

In some embodiments of the present invention, a relative motion sensor in the pen may be used to generate the digital ink, albeit less accurately than Netpage-based methods for generating digital ink. Examples of suitable motion sensors include at least one of: an accelerometer (typically a pair of orthogonal accelerometers), an optical mouse, a mechanical mouse or a gyroscope. Such techniques can usefully generate digital ink in scenarios where it is impractical or inconvenient for users to employ a substrate printed with a position-coding pattern.

Another possibility for generating digital ink is via detection of a wave signal emitted from a pen. The wave signal may be, for example, an ultrasonic wave, an infrared wave, a microwave, a radio wave etc.

US Publication No. 2011/0015893 (assigned to Epos Development Ltd) describes a pen with an ultrasonic emitter. The pen is suitable for writing on a passive substrate, such as plain paper, without requiring an underlying graphics tablet. A nearby device having a plurality of microphones receives the emitted ultrasonic signal from the pen and determines the pen's position relative to the device using time-of-arrival (TOA) measurement. In this way, the device can generate digital ink representing the path of the pen. The device may be, for example, a mobile phone or tablet computer positioned near the pen and paper.

Graphics tablets or digitizing tablets are well-known in the art. Such devices require a stylus to interact directly with an input surface of the tablet, or a sheet of paper placed over the input surface of the tablet. For example, tablets commercially available from Wacom and Acecad employ a grid of wires, which emit an electromagnetic wave signal to a stylus located above the tablet. An LC circuit in the stylus generates a signal, which is detected by the tablet and determines the position of the stylus relative to the grid. Other types of digitizing tablets employing resistive sensors, pressure sensors, acoustic sensors, optical sensors etc. will be readily apparent to the person skilled in the art.

Advances have been made in recent years to improve the accuracy of handwriting capture via capacitive touchscreens found on many portable electronic devices. Use of a capacitive stylus improves the accuracy of touchscreen input (compared with, say, a finger) so that digital ink representing handwriting may be generated by smartphones, tablet computers, PDAs etc. A plethora of capacitive styli suitable for tablet computers and the like are commercially available from suppliers, such as Boxwave, Acase and Belkin. Typically, digital ink may be generated by a tablet computer having a capacitive touchscreen receiving handwritten input from a capacitive stylus.

Accordingly, it will be appreciated that digital ink may be generated by a plethora of different devices and the present invention is not necessarily limited to one particular means of generating digital ink.

The present invention has been described with reference to a preferred embodiment and number of specific alternative embodiments. However, it will be appreciated by those skilled in the relevant fields that a number of other embodiments, differing from those specifically described, will also fall within the scope of the present invention. Accordingly, it will be understood that the invention is not intended to be limited to the specific embodiments described in the present specification, including documents incorporated by cross-reference as appropriate. The scope of the invention is only limited by the claims appended hereto.

1. A method of notetaking comprising the steps of:
displaying a source document on a first display device;
writing notes on a substrate relating to the displayed source document to create handwritten notes;
generating digital ink representing the handwritten notes; and
indexing the digital ink with at least one identifier for the displayed source document, such that said displayed source document is retrievable when accessing said notes, wherein said displayed source document has no association with said substrate prior to writing said notes.

2. The method of claim 1, wherein the substrate is a touchscreen and the notes are written using a stylus, and wherein a processor communicating with the touchscreen generates the digital ink.

3. The method of claim 1, wherein the substrate is a digitizing tablet and the notes are written using a stylus, and wherein the digitizing tablet generates the digital ink.

4. The method of claim 1, wherein the substrate is a passive substrate.

5. The method of claim 4, wherein the notes are written with a pen comprising a wave signal emitter, and wherein the digital ink is generated by a processor in communication with a wave signal detector configured for detecting the wave signals emitted by the pen.

6. The method of claim 5, wherein the pen comprises an ultrasonic emitter for emitting an ultrasonic wave signal and the digital ink is generated by a device comprising one or more microphones for receiving the ultrasonic wave signal and a processor for converting the received ultrasonic wave signal into digital ink.

7. The method of claim 4, wherein the notes are written with a pen comprising a motion sensor, and wherein the pen generates the digital ink using movement data determined by the motion sensor.

8. The method of claim 7, wherein the pen comprises at least one of: an accelerometer, a gyroscope, an optical mouse, and an optical image sensor.

9. The method of claim 7, wherein the substrate is printed with a position-coding pattern encoding a plurality of coordinate locations, and the pen comprises an optical image sensor for imaging the position-coding pattern and generating the digital ink using the imaged position-coding pattern.

10. The method of claim 9, wherein the position-coding pattern identifies a substrate identity and the digital ink generated by the pen identifies the substrate identity.

11. The method of claim 1, further comprising the steps of:
subsequently interacting with the handwritten notes; and
retrieving and displaying the source document on a second display device, said source document being a same source document displayed on said first display device at the time of writing said notes.

12. The method of claim 11, wherein said first and second display devices are the same display device.

13. The method of claim 1, wherein the source document comprises multiple pages and wherein the digital ink is indexed with a plurality of identifiers for a plurality of individual pages of said source document.

14. The method of claim 1, wherein said digital ink comprises first and second digital ink strokes, and wherein a first digital ink stroke is indexed with a first displayed source document and a second digital ink stroke is indexed with a second displayed source document.

15. The method of claim 1, wherein the source document is a multimedia document comprising one or more of: text, graphics, audio and video content.

16. The method of claim 1, wherein the source document is an e-book, a pdf document, a slideshow presentation, a spreadsheet or an internet webpage.

17. The method of claim 16, wherein the identifier is an electronic bookmark identifying one chapter or one page of said e-book.

18. The method of claim 1, wherein the first display device is a tablet computer, an e-book viewer, a laptop computer, a mobile phone or a personal digital assistant.

19. The method of claim 1, further comprising the steps of:
sending the digital ink to the first display device in real-time; and
the first display device indexing the received digital ink with the identifier for the displayed source document.

20. The method of claim 1, further comprising the steps of:
generating the digital ink in the first display device in real-time; and
the first display device indexing the received digital ink with the identifier for the displayed source document.
